(19) United States
(12) Patent Application Publication
(10) Pub. No.: US 2015/0349436 A1
(43) Pub. Date: Dec. 3, 2015

(54) ELECTRICAL TERMINAL ASSEMBLY

(71) Applicant: KABUSHIKI KAISHA TOSHIBA, Tokyo (JP)

(72) Inventor: Yasuki Torigoshi, Tachikawa Tokyo (JP)

(21) Appl. No.: 14/573,166

(22) Filed: Dec. 17, 2014

Related U.S. Application Data
(60) Provisional application No. 62/003,647, filed on May 28, 2014.

(51) Int. Cl. H01R 4/18

(52) U.S. Cl. CPC H01R 4/18

(57) ABSTRACT

According to one embodiment, an electrical terminal assembly includes an internal contact at one end portion, the internal contact being connected to a connector terminal, an external contact at the other end portion, and a fixing portion between the internal contact and the external contact, the fixing portion fixing a wire. The external contact is outside a connector when the electrical terminal assembly is inserted into the connector.

### CROSS-REFERENCE TO RELATED APPLICATIONS

This application claims the benefit of U.S. Provisional Application No. 62/003,647, filed May 28, 2014, the entire contents of which are incorporated herein by reference.

### FIELD

Embodiments described herein relate generally to an electrical terminal assembly.

### BACKGROUND

To connect a wire to a base, another wire, or the like, a connection terminal is attached to the tip of the wire. The easiest attachment method is to solder the connection terminal to the tip of the wire. However, soldering is originally poor in strength, and its strength may deteriorate because of vibration and heat. In recent years, by accommodating wires in U-shaped grooves of connection terminals which are U-shaped in cross section and cover the tips of the wires, and applying physical pressure to the terminals by means of a dedicated tool, the wires are fixed to the terminals without soldering. Such solderless terminals are called crimp-type terminals or insulation-displacement-connection terminals.

On the other hand, with respect to electronic apparatuses, it is important to take measures against noise. In electronic apparatuses, when a signal is propagated from a certain apparatus or circuit to another apparatus or circuit through wiring, noise generated from the certain apparatus or circuit is also propagated to the other apparatus or circuit. This noise is called conduction noise. Noise which is generated from the certain apparatus or circuit and is directly emitted into the air is called spatial noise. Conduction noise is emitted into the air during propagation and can change into spatial noise. One of the measures to inhibit conduction noise is ground reinforcement, and it is desirable to surely connect a ground wire to ground level in the state where a crimp-type terminal is connected to a connector.

However, with respect to a crimp-type terminal, because of its terminal structure, only one wire can be connected to one terminal. Thus, a ground wire cannot be connected to ground level close to a connector in the state where the crimp-type terminal is connected to the connector. To inhibit propagation noise, it is desirable to reduce as many extra wires as possible and connect the ground wire to ground level close to the connector.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1A and FIG. 1B are perspective illustrations of an electrical terminal assembly according to a first embodiment.

FIG. 2A and FIG. 2B are illustrations of the electrical terminal assembly shown in FIG. 1, seen from the bottom and the side, respectively.

FIG. 3A and FIG. 3B are illustrations of the state in which the electrical terminal assembly shown in FIG. 1A is inserted into a connector, seen from the top and the side, respectively.

FIG. 4A and FIG. 4B are illustrations of a wiring portion of an example of an electronic apparatus using the electrical terminal assembly of the first embodiment, seen from the top and the side, respectively.

FIG. 5A and FIG. 5B are illustrations of a wiring portion of an example of an electronic apparatus using an electrical terminal assembly of a second embodiment, seem from the top and the side, respectively.

FIG. 6A and FIG. 6B are illustrations of the electrical terminal assembly of the second embodiment, seen from the bottom and the side, respectively.

FIG. 7A and FIG. 7B are illustrations of a wiring portion of an example of an electrical terminal assembly of a third embodiment, seen from the top and the side, respectively.

### DETAILED DESCRIPTION

Various embodiments will be described hereinafter with reference to the accompanying drawings.

In general, according to one embodiment, an electrical terminal assembly includes an internal contact at one end portion, an external contact at the other end portion, and a fixing portion. The internal contact is connected to a connector terminal. The fixing portion is between the internal contact and the external contact. The fixing portion fixes a wire. The external contact is outside the connector when the electrical terminal assembly is inserted into the connector.

Crimping is to apply high pressure between a conductor wire which is made of a copper wire stripped of an insulator or the like, and a crimp-type terminal which is similarly made of an electrical conductor such as copper, thereby generate a molecular melting phenomenon (covalent bond) between the terminal and the conductor wire, integrate both of them, and substantially erase a boundary (make permanent connection). The wire can be thereby fixed to the terminal without the need for minute manual work such as soldering. Those similar to crimping include insulation displacement connection, which is to press a wire with an insulator into a U-shaped groove of a terminal at high pressure, thereby break through the insulator of the wire and catch a conductor wire by a spring power of the U-shaped groove, and connect both of them. Thus, it is conceivable that contact is made by the spring power of the U-shaped groove; however, a contact cross section is similar to conductor wire deformation of crimping. In this specification, such insulation displacement connection is also included in crimping.

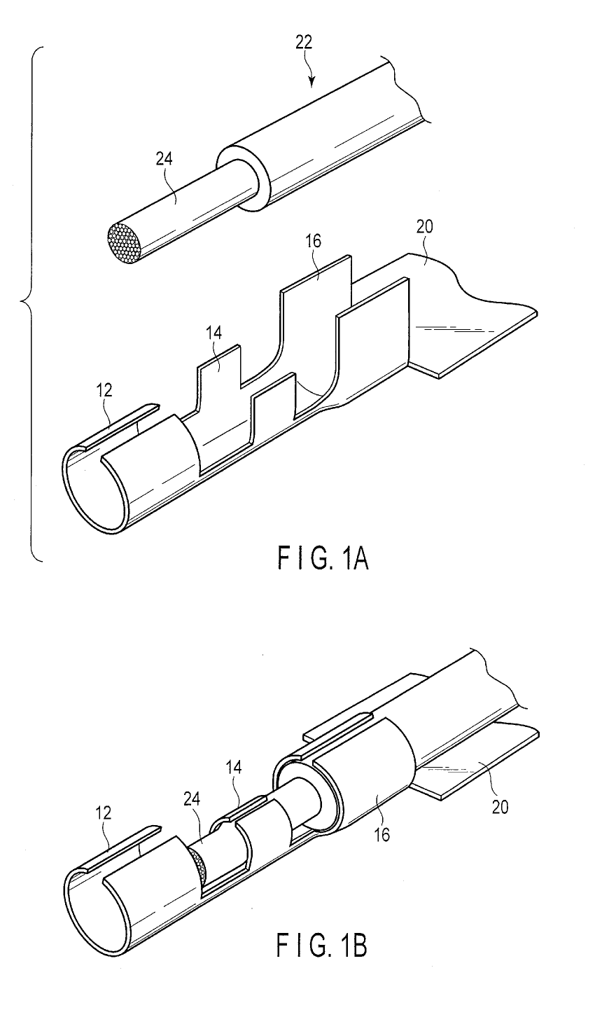

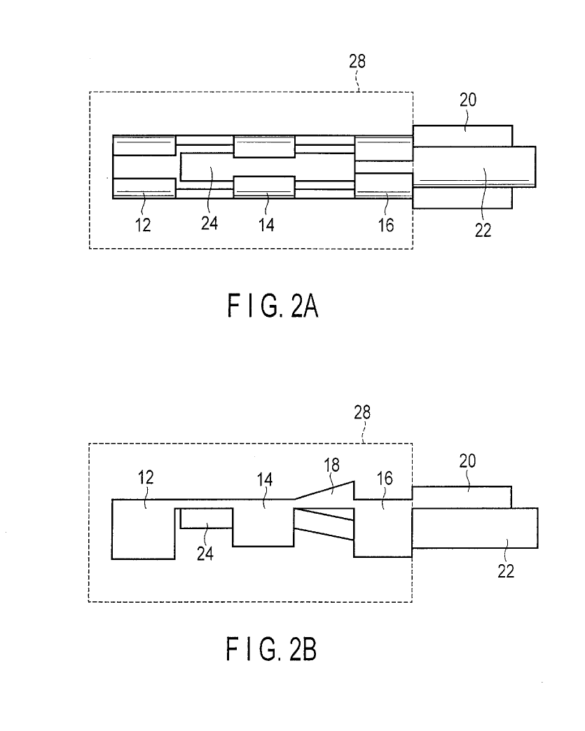

FIG. 1A and FIG. 1B are perspective illustrations showing an example of a crimp-type solderless terminal according to a first embodiment. FIG. 1A shows separate states before a wire is fixed to the crimp-type terminal, and FIG. 1B shows a state in which the wire is fixed to the crimp-type terminal. FIG. 2A is an illustration of the terminal in the state of FIG. 1B, seen from the top, and FIG. 2B is an illustration seen from the side. Also, for convenience in explaining an attachment method, FIG. 1A and FIG. 1B show the states in which the wire is fitted from above the crimp-type terminal and the crimp-type terminal is located under the wire. However, in actual use, the crimp-type terminal is often located over the wire as shown in FIG. 2B. This is for connecting the wire to another conductor by using an external contact after inserting the terminal into a connector, the details of which will be described later.

A crimp-type terminal formed by carrying out pressing or the like of a conductor such as copper is attached to a tip portion of a wire 22. The tip portion of the wire 22 is stripped of an insulator, and a conductor wire 24 is exposed. The crimp-type terminal is originally made of a piece of thin plate-like member, and a pair of barrels rises vertically from both sides of a semicylindrical thin base to catch a wire placed on the base from right and left. Then, by crimping the barrels at high pressure with a dedicated processing tool not shown in the figures, the barrels curve and closely fasten the circumference (at least 180 degrees) of the wire. Thus, soldering is unnecessary and the wire can be easily fixed to the terminal. Since manufacture is easy, the costs are also lowered.

At the tip portion of the crimp-type terminal, an internal contact 12 is formed. The internal contact 12 has a cylindrical shape so that a connector terminal (or referred to also as a pin) in a connector is inserted thereinto when the crimp-type terminal is inserted into the connector. By connecting the internal contact 12 and the connector terminal, the wire is connected to the connector. The lower part of the internal contact 12 is formed integrally with the base. Forward of the internal contact 12, a conductor-wire fixing portion 14 composed of a pair of barrels rising from the base is formed to leave a space from the internal contact 12. Forward of the conductor-wire fixing portion 14, an insulator fixing portion 16 composed of a pair of barrels rising from the base is formed to leave a space from the conductor-wire fixing portion 14. The insulated wire 22 is fixed to the crimp-type terminal by the insulator fixing portion 16, and the conductor wire 24 is fixed to the crimp-type terminal by the conductor-wire fixing portion 14. A lance 18 is formed on the back side of the base between the conductor-wire fixing portion 14 and the insulator fixing portion 16, such that the crimp-type terminal inserted into the connecter is not easily pulled out. As described above, the crimp-type terminal is formed by pressing, and thus, the base, the internal contact 12, the conductor-wire fixing portion 14, the insulator fixing portion 16 and the lance 18 are integrated.

Moreover, forward of the insulator fixing portion 16, a plate-like external contact 20 is formed. The external contact 20 is integrated with a bottom portion of the insulator fixing portion 16. In other words, the base of the terminal is extended in a handy direction (an external direction of the connector), and the external contact 20 is formed at an extended portion. When the crimp-type terminal is inserted into a connector 28, the external contact 20 is not inserted into the connector 28 and remains outside the connector 28. Thus, by using the external contact 20, a desired wire can be connected to a desired wire or a desired electric potential, for example, ground level, close to the connector. Because the external contact 20 has a certain size, the external contact can be connected to another conductor by a method other than soldering.

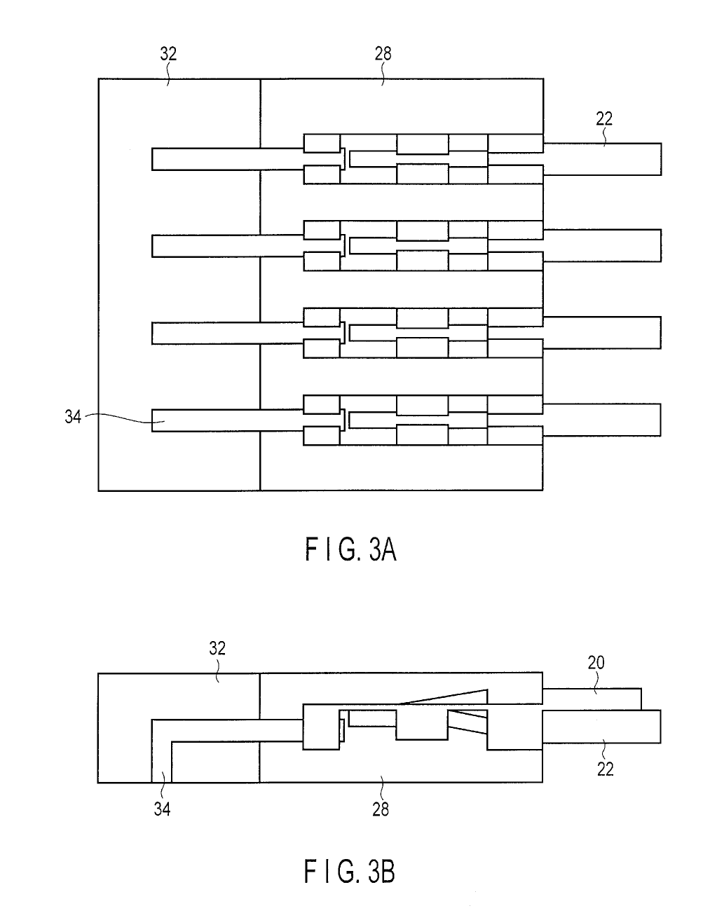

A wire connecting electronic apparatuses/circuits is actually composed of a plurality of wires. FIG. 3A is an illustration of the connector 28 into which, for example, four wires are inserted together, seen from the top. FIG. 3B is an illustration seen from the side. To the back surface of the connector 28, another connector 32 including a projecting connector terminal 34 is connected, and the tip of the connector terminal 34 is inserted into the internal contact 12 of the crimp-type terminal. The connector terminal 34 is connected to another wire.

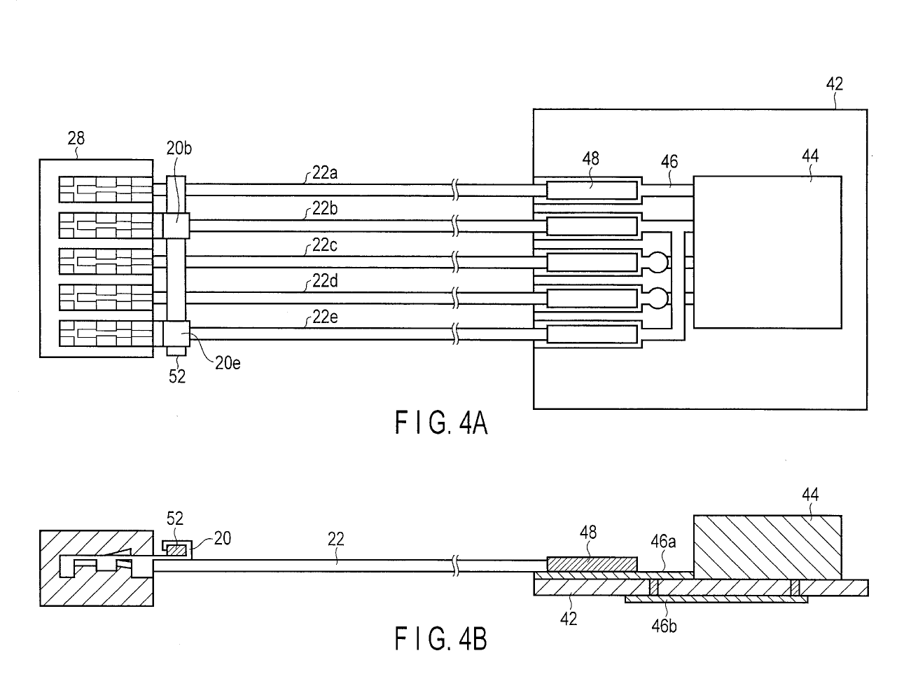

FIG. 4A and FIG. 4B are a top view and a side view, respectively, showing a specific implementation example of a wire having the crimp-type terminal of the present embodiment. Here, the case of being applied to a notebook PC composed of the body of a computer and a display unit will be described. A camera is provided at the display unit, which is freely opened and closed toward the body of the computer. A signal from the camera is supplied to a motherboard in the body of the computer through a wire. The display unit is attached to the body of the computer through a hinge. Although a flexible wire is used in the body of the computer, a flexible wire cannot be used in a hinge portion, and thus a wire made of a normal cable is used therein. A normal wire passes through the hinge portion and is connected to a connector in the body of the computer, and the connector is connected to an electronic circuit on the motherboard through the flexible wire.

On a device base 42, a camera (IC device) 44 such as a CCD and a driver, a front-layer wire 46a and a back-layer wire 46b are formed. To the IC device 44, the front-layer wire 46a and the back-layer wire 46b are connected. A large number of wiring patterns are formed on the front-layer wire 46a, and one ends of a signal wire 22a, a ground wire 22b, signal wires 22c and 22d and a detect wire 22e are connected to the respective wiring patterns through a solder 48. In general, when a signal from a certain device is transmitted to a subsequent stage through a connector, it is sometimes desired to detect connection of a device (or a wire) to a connector. To meet this, the detect wire 22e, which is connected to the ground when a terminal of the wire is inserted into the connector, is prepared, and whether the device is connected to the connector or not is detected by seeing an electric potential of the detect wire (detecting insertion when it is zero). Thus, the detect wire 22e needs to be connected to the ground on a wire side. On the device base 42, a wiring pattern to which the detect wire 22e is soldered is connected to a wiring pattern to which the ground wire 22b is soldered. However, because there is a distance from the connector 28 to the device base 42, a level of the detect wire 22e between them is unstable, and an electromagnetic interference (EMI) may Occur.

Crimp-type terminals are attached to the other ends of the signal wire 22a, the ground wire 22b, the signal wires 22c and 22d and the detect wire 22e. To the other ends of the ground wire 22b and the detect wire 22e, the crimp-type terminals described above with reference to FIG. 1B are attached. To the other ends of the signal wires 22a, 22c and 22d, terminals obtained by omitting the external contact 20 from the crimp-type terminals described above with reference to FIG. 1B are attached. External contacts 20b and 20e of the crimp-type terminals attached to the ground wire 22b and the detect wire 22e are connected to each other through a conductive bar 52. Thus, if the wires 22a, 22b, 22c, 22d and 22e are connected to the connector 28, the detect wire 22e is connected to the ground wire 22b close to the connector 28, an electric potential of the detect wire 22e reaches ground level, and the electronic circuit on the motherboard subsequent to the connector can detect that the IC device 44 is connected to the connector 28. Because the signal wires 22a, 22c and 22d do not need to be connected to other conductors outside the connector, the external contact 20 is unnecessary.

Attachment methods of the conductive bar 52 includes, if the conductive bar 52 is flat, a method of folding back the external contacts 20b and 20e in advance and forming them into such a shape as catches the conductive bar 52, and after inserting the conductive bar 52, further folding them inside so that the bar is not pulled out, a method of placing the conductive bar 52 on the flat external contacts 20b and 20e and then folding back the external contacts 20b and 20e twice to wrap the bar 52, and the like. If the conductive bar 52 has the shape of a rod, a method of forming a circular depression having a shape into which a rod is fitted at the external contact 20 and narrowing an opening after fitting the rod is also included.

For the other wires which do not need to be connected to the ground, i.e., the signal wires 22a, 22c and 22d, a crimp-type terminal without the external contact 20 is used. Thus, a first type of a crimp-type terminal with the external contact 20 and a second type of a crimp-type terminal without the external contact 20 are prepared, and the first and second crimp-type terminals are selectively used according to the type of a wire. A method of attaching a crimp-type terminal with the external contact 20 to all the wires and catching the conductive bar 52 by folding only an external contact of a terminal which needs to be connected is not applied in order to avoid the possibility, of an extra short to the utmost. Such a structure enables an improvement in manufacturability.

By using the external contact 20, which is integrally formed at a crimp-type terminal in this manner and is not inserted into a connector even if the crimp-type terminal is inserted into the connector, the detect wire 22e can be connected to the ground wire 22b close to the connector. Thus, a signal for insertion detection is not propagated over a long distance from the connector 28 to the device base 42, the generation of propagation noise is inhibited, and there is no risk of EMI occurring. If the external contacts 20b and 20e and the conductive bar 52 are not used, a signal from the electronic circuit at a subsequent stage is propagated to the device base 42 through the detect wire 22e, and there, is connected to the ground wire 22b. Thus, a portion where the level of the detect wire 22e is unstable is long and become a factor of EMI. EMI tends to occur where there is a change in structure. At a portion of a connector, a shape changes and thus EMI tends to occur. Therefore, to surly connect a ground wire to ground level just before it enters a connector has the advantage of inhibiting the propagation of noise and preventing EMI from having an influence.

Although FIG. 4A shows only one ground wire, if there are a plurality of ground wires, ground level becomes more stable and the effect of a provision for EMI is increased by connecting the plurality of ground wires each other using an external contact and a conductive bar.

As described above, according to the embodiment, the structure of a crimp-type terminal is somewhat changed, a conductive portion (external contact) is extended to the outside of a connector, and a conductor wire can be easily connected to the ground outside the connector. If there is no external contact, in order to connect the conductor wire to the ground outside the connector, it is necessary to strip an insulator outside the connector and solder a grounded wire to a conductor wire. However, because soldering close to a connector is almost impossible, there is a fault that a portion connected to the ground is distant from the connector and EMI tends to occur according to a distance. Thus, according to the embodiment, a problem in structure of a crimp-type terminal that only one wire can be connected to one terminal can be avoided.

With respect to a USB terminal, although a shell surrounding the terminal is grounded, in the embodiment, a wire can be connected to another conductor outside a connector by changing (extending) somewhat the shape of the terminal itself without adding a large member such as the shell. Thus, the manufacturability of a terminal is good and a reduction in cost can be achieved.

Hereinafter, another embodiment will be described. Portions corresponding to those of the first embodiment will be given the identical reference numbers and the detailed explanations thereof will be omitted.

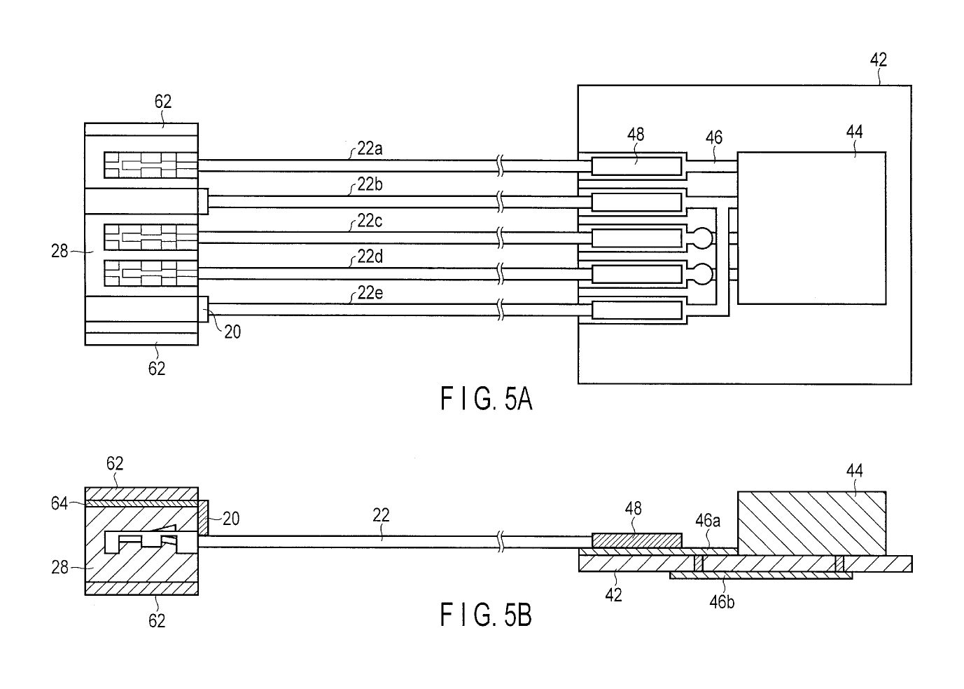

FIG. 5A and FIG. 5B are illustrations of an electronic apparatus using an electrical terminal assembly of a second terminal, seen from the top and the side, respectively. Although in the first embodiment, the detect wire 22e is connected to the ground wire 22b by folding the external contact 20 back and catching the conductive bar 52, in the second embodiment, the detect wire 22e is connected to the ground wire 22b by folding (raising) the external contacts 20b and 20e 90 degrees and connecting them to an end face of a metal shell 62 covering the periphery of the connector 28. The external contact 20 is further folded, and contacts the metal shell 62 as a contact 64.

The metal shell 62 may cover the whole periphery of the connector 28, or may be partially formed. Although not being shown in the figures, the metal shell 62 is grounded.

Also according to the second embodiment, the detect wire 22e can be connected to the ground wire 22b close to the connector. Thus, a signal for insertion detection is not propagated through a wire over a long distance, the generation of propagation noise is inhibited, and there is no risk of EMI occurring.

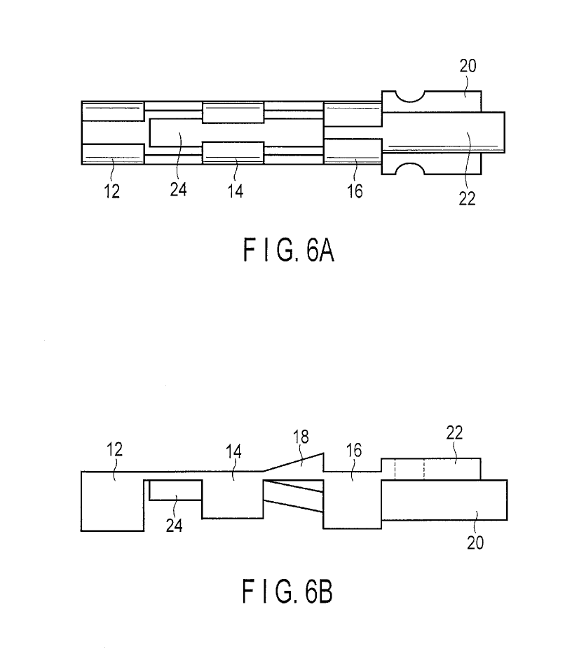

Also, the external contact 20 may be provided with cutouts at a folded portion so as to be easily folded, as shown in FIG. 6A and FIG. 6B. FIG. 6A and FIG. 6B are illustrations of the electrical terminal assembly of the second embodiment, seen from the bottom and the side, respectively. Although the cutouts have the shape of a circular arc as an example, they may have other shapes such as a rectangular shape. Alternatively, instead of the cutouts, the thickness of the contact 20 at a folded portion may be thinned. Further, when a crimp-type terminal is formed by pressing, barrels as fixing portions may be vertically raised from a base (in a top and bottom relationship shown in FIG. 1A) and the external contact 20 may be raised on the opposite side.

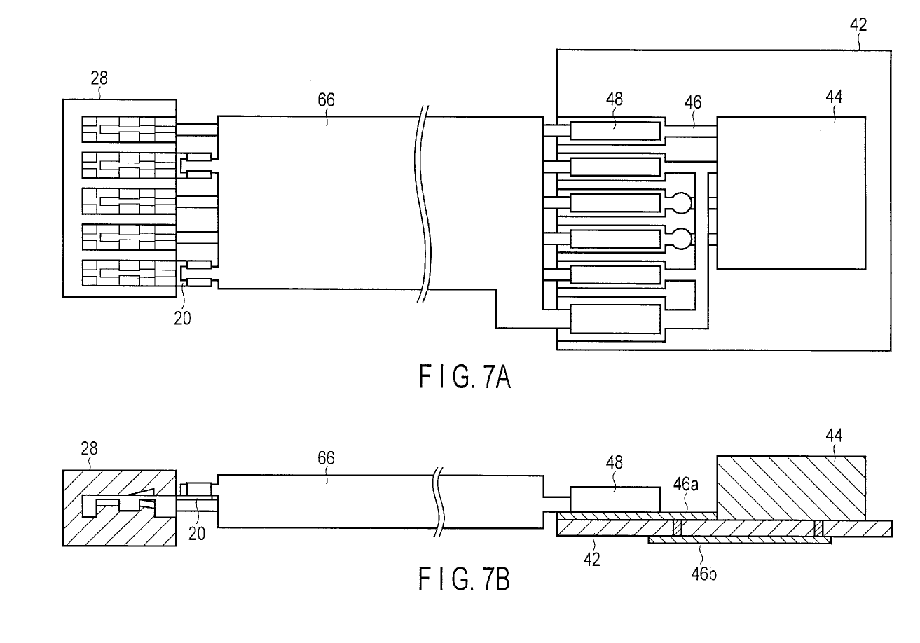

FIG. 7A and FIG. 7B are illustrations of a wiring example of an electronic apparatus using an electrical terminal assembly of a third embodiment, seen from the top and the side, respectively. The third embodiment shows an example in which a shield plate 66 covering the whole wiring is provided. On the device base 42, a wiring pattern to which the detect wire 22e is soldered is connected to a wiring pattern to which the ground wire 22b is soldered, and further, another wiring pattern is also connected to these wiring patterns. The shield plate 66 is soldered to the other wiring pattern.

On the other hand, on the shield pattern 66 on a connector side, rectangular projections which are as wide as a wire are formed at places close to the connector which correspond to the tips of the grand wire 22b and the detect wire 22e. These projections are fixed to the external contacts 20 of the ground wire 22b and the detect wire 22e. Fixing methods include a method of providing the external contacts 20 with protrusions into which the projections are fitted and fitting the projections into the protrusions, and the like.

Connecting the shield plate 66 covering the whole wiring, a ground wire, and a detect wire close to a connector in this manner brings the advantage that the whole shield plate 66 becomes stable and EMI emissions are reduced.

According to the above embodiment, an electrical terminal assembly which can easily fix a wire without the need for soldering by applying a high pressure and catching the wire can be provided. Since the structure of a terminal is somewhat changed such that it has a contact which is not inserted into a connector when the electrical terminal assembly is inserted into the connector and is located outside, a desired wire can be connected to a desired wire or electric potential close to the connector even if the terminal is in the state of being inserted into the connector.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. For example, the shape of an external contact is not restricted to those of the above-described examples and can be arbitrarily changed according to the shape of a conductor to be connected. Also, although the metal of a terminal has been described as copper or the like, it is not restricted in any way.

What is claimed is:

1. An electrical terminal assembly comprising:
an internal contact at one end portion, the internal contact being connected to a connector terminal;
an external contact at the other end portion; and
a fixing portion between the internal contact and the external contact, the fixing portion fixing a wire,
wherein the external contact is outside the connector when the electrical terminal assembly is inserted into the connector.

2. The electrical terminal assembly of claim 1, wherein
the fixing portion comprises a conductor-wire fixing portion and an insulator fixing portion,
the conductor-wire fixing portion surrounds the periphery of a conductor wire of the wire over 180 degrees,
the insulator fixing portion surrounds the periphery of an insulator of the wire over 180 degrees, and
the external contact is integrated with the insulator fixing portion.

3. The electrical terminal assembly of claim 1, wherein
the external contact fixes one end of a conductor member, and
the other end of the conductor member is connected to an external contact of an electrical terminal assembly of a ground wire.

4. The electrical terminal assembly of claim 3, wherein the external contact has the shape of a flat plate, and fixes the conductor member to make it wrapped.

5. The electrical terminal assembly of claim 3, wherein the external contact fixes the conductor member connected to a detect wire.

6. The electrical terminal assembly of claim 1, wherein the external contact is connected to a conductor shell portion of the periphery of the connector.

7. The electrical terminal assembly of claim 1, wherein the external contact has the shape of a flat plate, and is folded to touch the conductor shell portion.

8. The electrical terminal assembly of claim 7, wherein the flat plate has a cutout on the folded portion.

9. The electrical terminal assembly of claim 1, wherein the external contact is connected to a shield plate covering the wire.

10. The electrical terminal assembly of claim 9, wherein the shield plate is connected to a ground wire and a detect wire.

11. The electrical terminal assembly of claim 1, wherein
the internal contact, the fixing portion and the external contact are integrated on a base, and
the base further comprises a lance integrated.
